(19) United States
(12) Patent Application Publication
(10) Pub. No.: US 2025/0202723 A1
(43) Pub. Date: Jun. 19, 2025

(54) BLOCKCHAIN DATA PROCESSING

(71) Applicant: THE BLOCKHOUSE TECHNOLOGY LIMITED, Oxford (GB)

(72) Inventor: Andrew William ROSCOE, Oxford (GB)

(73) Assignee: THE BLOCKHOUSE TECHNOLOGY LIMITED, Oxford (GB)

(21) Appl. No.: 18/848,878

(22) PCT Filed: Mar. 22, 2023
(86) PCT No.: PCT/GB2023/050729

§ 371 Date: Sep. 19, 2024

(30) Foreign Application Priority Data
Mar. 23, 2022 (GB) 2204103.2

(51) Int. Cl. H04L 9/00; G06F 21/64

(52) U.S. Cl. CPC H04L 9/50; G06F 21/64

(57) ABSTRACT

A method of processing transaction data for inclusion in a blockchain comprises creating a candidate block of transaction data, determining a set of verifier nodes from a plurality of nodes of the blockchain network, and sending the candidate block to each of the verifier nodes for verification. The verifier nodes are identified by identifying nodes that have each created a respective block that has been included in the blockchain within a predetermined period prior to the creating of the candidate block.

### BACKGROUND OF THE INVENTION

This invention relates to methods and apparatus for processing transaction data for inclusion a blockchain network.

A key feature of many blockchain networks is the absence of a central controller that is responsible for storing and maintaining the data stored on the blockchain. Instead, the blockchain is a decentralised distributed ledger, with a plurality of nodes of the blockchain network all maintaining copies of the blockchain. Block-creating nodes create new candidate blocks for inclusion in the blockchain. Other block-creating nodes receive and verify these candidate blocks, before including them in their local copies of the blockchain once they pass the verification process.

Consensus mechanisms provide a way for nodes of the blockchain network to agree upon whether or not a particular block should be included in the blockchain. They limit the potential for malicious nodes to corrupt the blockchain, e.g. by attempting to reverse the blockchain so as to double-spend cryptocurrency. Common consensus mechanisms are based on Proof of Work (PoW) or Proof of Stake (PoS) and provide procedures for processing transaction data to be included in the blockchain with the purpose of dissuading or preventing nodes from behaving maliciously.

However, the present invention seeks to provide improved methods for efficiently processing transaction data for inclusion in a blockchain whereby the integrity of the blockchain may be further increased.

### SUMMARY OF THE INVENTION

When viewed from a first aspect, the invention provides a method of processing transaction data for inclusion in a blockchain hosted by a blockchain network comprising a plurality of nodes, the method comprising:
creating a candidate block of transaction data;
determining a set of verifier nodes by identifying nodes of the blockchain network that have each created a respective block that has been included in the blockchain within a predetermined period prior to the creating of the candidate block; and
sending the candidate block to each of the verifier nodes for verification.

Thus it will be appreciated that embodiments of the present invention provide a novel way of processing transaction data for inclusion in a blockchain, whereby a subset of block-creating nodes, all of which have recently created a block of the blockchain, are provided with subsequent candidate blocks for verification. These “verifier” nodes can be considered more trustworthy than other nodes (including other block-creating nodes) of the blockchain network because, by having recently created (e.g. mined) blocks that have been successfully included in the blockchain, they have demonstrated a recent interest in the blockchain and a conformance with the rules of the blockchain network. This makes it unlikely such nodes would conspire to harm the blockchain. As the set of verifier nodes is determined according to the recency of the nodes' block-creating activity, the set of verifier nodes may be considered to be an up-to-date representation of trustworthy nodes of the blockchain network. This approach may also build on and benefit from the efforts that conventional consensus protocols take to choose representative and reasonably trustworthy sets of nodes to act as block creators. These efforts can be further supplemented by requiring evidence that the blocks nodes create meet verification criteria before they are included in the blockchain, and therefore before the node can be considered for inclusion in the set of recent-block-creator nodes. Entrusting the verification of blocks to a selected subset of block-creating nodes is an efficient way of ensuring the security of the network.

Blockchain networks configured to implement such a method may thus enable a more efficient approach for reaching consensus by the fair choice of a committed set of arbitrators (i.e. the recent-block-creator nodes) for blocks. They may also provide a mechanism for deciding when these arbitrators have made a trustworthy decision; this should almost always be the case in most practical contexts and so provide for efficient decision making.

The plurality of nodes may include block-creating nodes and optionally non-block-creating nodes. Such non-block-creating nodes may, for example, create transaction data, which they may send to a block-creating node for inclusion in the blockchain. Each of the block-creating nodes may store a version (i.e. a local copy) of the blockchain in a memory of the node. The network may include block-creating nodes that are not in the set of verifier nodes (and typically will do so).

In some embodiments, the blockchain is configured to store cryptocurrency. In some embodiments, the blockchain is configured to store smart contracts.

Preferably the method comprises receiving the candidate block of transaction data at each of the set of verifier nodes. The transaction data may relate to cryptocurrency transactions or smart contract transactions or both. Preferably the candidate block is created from a pool of unverified transaction data.

The verifier nodes may use a common protocol to determine a validity of each candidate block—e.g. to decide whether it is good, bad or undecided. Preferably the method comprises each of the verifier nodes verifying the candidate block by determining whether the candidate block meets one or more verification criteria. The verification criteria may include that the block must be correctly formatted; and/or not include a double spend of cryptocurrency; and/or contain a required endorsement; and/or provide evidence that a node that created the block had a right to do so (e.g. being associated with a winning ticket). In preferred embodiments, any or all of these criteria may be members of a set of primary verification criteria, e.g. as is described in more detail below. The verification criteria may include that the block should meet one or more timing deadlines; and/or include certain non-critical information. In preferred embodiments, any or all of these criteria may be members of a set of secondary criteria, e.g. as is described in more detail below.

In some embodiments, each of the verifier nodes is configured to communicate with at least one, and preferably all, of the other verifier nodes. Preferably the method comprises determining whether to include the candidate block in the blockchain. For a particular candidate block it may comprise allowing the candidate block. The method may comprise determining whether to reject the candidate block from inclusion in the blockchain. For a particular candidate block it may comprise rejecting the candidate block. Each of these determinations is preferably made using the respective determinations made by each of the verifier nodes in verifying the candidate block. Although such a determination could be made by a central authority, it is preferably made in a distributed manner by the set the verifier nodes. It may be made according to a consensus protocol, e.g. as described below.

Preferably the method comprises, in response to determining that at least one of the set of verifier nodes has determined that the candidate block does not meet the verification criteria, rejecting the candidate block.

A verifier node may communicate with the other verifier nodes by outputting verification data. The verification data is preferably readable by each of the plurality of verifier nodes; preferably any failure to satisfy a primary verification criterion can be evidenced in terms of the candidate block and its predecessors. The verification data may be sent to each of the verifier nodes (e.g. directly pushed); it may be sent by unicast or multicast or broadcast. However, in some embodiments, at least some of the verification data output by a verifier node is published on a data server (e.g. a bulletin board) hosted by the verifier node. Some of the verification data may be sent to a data server hosted by another node of the network (e.g. another of the verifier nodes). Preferably the or each data server is readable by each of the verifier nodes. The or each data server may be readable by all of the plurality of block-creating nodes of the blockchain network, and optionally by some or all non-block-creating nodes of the network.

Outputting some or all of the verification data to the other verifier nodes and/or to a data server that is readable by other nodes of the network allows each verifier node's verification of the candidate block to be determined, and potentially checked, by other nodes.

The verification data preferably indicates whether the verifier node has determined that the candidate block meets the verification criteria. Thus, preferably the method comprises outputting verification data indicating whether each of the verifier nodes has determined that the candidate block meets the verification criteria. The respective verification data output by each of the verifier nodes may comprise evidence data indicating a reason for the determination made by the respective verifier node as to whether the candidate block meets the verification criteria. The evidence data may comprise some or all of the data used by a verifier node in order to determine whether the candidate block meets the verification criteria. In some embodiments, a verifier node is configured to output evidence data when the verifier node determines that the candidate block does not meet the verification criteria.

In some embodiments, a verifier node is configured to output evidence data to a data server (e.g. a public bulletin board hosted by the verifier node) before the evidence data is used by the verifier node to determine whether the candidate block meets the verification criteria. This can mean that it is apparent to other nodes what information a verifier node has used to make its decision. As a result, it may be easier to determine if a verifier node is acting maliciously or carelessly.

As disclosed in more detail below, in some embodiments verifying the candidate block comprises each of the verifier nodes assigning a category to the candidate block. The category preferably depends on the determination made by the respective verifier node as to whether the candidate block meets the verification criteria. Preferably, the verification data output by a verifier node comprises data representative of the category assigned to the candidate block by the verifier node. The verification data output by a verifier node preferably comprises data representative of one or more verification criteria that the verifier node has determined that the candidate block does not meet.

Preferably the verification criteria comprise one or more primary verification criteria, preferably corresponding to one or more requirements that the candidate block must meet in order for the candidate block to be included in the blockchain. Preferably the verification criteria comprise one or more secondary criteria, preferably corresponding to one or more non-essential requirements that it is desirable, but not essential, for the candidate block to meet.

Each of the verifier nodes may categorise the candidate block into one of two categories: a first (“pass”) category, indicating that the respective verifier node has determined that the candidate block meets the verification criteria, or a second (“fail”) category, indicating that the respective verifier node has determined that the candidate block does not meet the verification criteria. However, preferably the method comprises each of the verifier nodes categorising the candidate block into one of three categories: a first (“green”) category, indicating that the candidate block meets all of a set of one or more primary verification criteria (e.g. as disclosed above) and all of a set of secondary verification criteria (e.g. as disclosed above); a second (“amber”) category, indicating that the candidate block meets all of the primary verification criteria but does not meet all of the secondary verification criteria; or a third (“red”) category, indicating that the candidate block does not meet all of the primary verification criteria.

Preferably the method comprises, in response to a majority of the verifier nodes determining that the candidate block meets all of the primary verification criteria (i.e. categorising the candidate block as “green” or “amber”), and none of the verifier nodes determining that the candidate block does not meet all of the primary verification criteria (i.e. “red”), allowing the candidate block to be added to the blockchain and/or adding the candidate block to the blockchain. Allowing the candidate block to be added to the blockchain may comprise each of a plurality of block-creating nodes adding the block to a respective local copy of the blockchain (i.e. stored by the node). One or more of these nodes may output an updated copy of the blockchain to other nodes of the blockchain network (e.g. to a non-block-creating node).

Imposing a requirement to pass such a verification process before a block is included in the blockchain may help further increase trust in the nodes selected for inclusion in the set of recent block creators, since a block-creating node can only be included once a block it has created has been successfully verified.

Preferably the method comprises, in response to a majority of the verifier nodes determining that the candidate block does not meet one or more of the primary verification criteria, rejecting the candidate block from inclusion in the blockchain. This may comprise every or at least a majority of nodes that received the candidate block not including it in a respective local copy of the blockchain. If one or more nodes do nevertheless include the candidate block in a local copy, the network may detect and remove such copies, e.g. by implementing anti-forking technology such as a longest-chain rule or an approach as described in the applicant's earlier patent application WO 2021/204181—“Method And Device For Preventing Forking Of Blockchain”.

In some embodiments, a disagreement among the set of verifier nodes (i.e. conflicting categorisations of the candidate block) may be resolved by the verifier nodes accessing verification data output by one or more other verifier nodes, and using the verification data to categorise the candidate block again. As explained below, this can allow a node to draw on additional information that may only have been available to some of the verifier nodes during the first verification.

Alternatively or additionally, in some embodiments a disagreement may be resolved by sending the candidate block to a wider set of nodes for verification. This means that, even in a situation in which a majority of the set of verifier nodes were compromised and were acting maliciously to undermine the blockchain, even a single uncompromised verifier node can potentially prevent an attack on the blockchain, by issuing a “red” categorisation and thereby causing the candidate block to be scrutinised by a wider set of nodes. This can significantly increase the robustness of the blockchain. In essence, in some embodiments, the blockchain may be configured to accept blocks that the current set of verifier nodes deem good and to reject blocks the current set of verifier nodes deem bad, while decisions about others blocks (e.g. undecided blocks) are taken on by a larger pool of secondary verifiers.

Thus, preferably, the method comprises, in response to determining that i) a majority of the verifier nodes have determined that the candidate block meets all of the primary verification criteria; and ii) at least one of the verifier nodes has determined that the candidate block does not meet one or more of the primary verification criteria, one or each of the verifier nodes sending the candidate block to one or more further nodes of the plurality of nodes for further verification.

The one or more further nodes (i.e. the wider set of nodes) may be all of the nodes of the blockchain network (i.e. all active nodes), or it may be a subset of all nodes. The one or more further nodes may be selected at random by the network (e.g. by the set of verifier nodes) from the plurality of nodes. The one or more further nodes may be determined by identifying nodes of the blockchain network that have each created a respective block that has been included in the blockchain within a second predetermined period prior to the creating of the candidate block, wherein the second predetermined period is longer than the predetermined period. In some embodiments, the one or more further nodes may comprise, or be selected from, nodes that have at least a minimum level of deposit or stake in the network.

Preferably the method comprises identifying one or more dissenting verifier nodes, wherein a dissenting verifier node is a verifier node that has made a different determination regarding whether the candidate block meets the verification criteria than a majority of the verifier nodes. In other words, the one or more dissenting verifier nodes are verifier nodes that disagree with the consensus of the set of verifier nodes. For example, where a majority of the verifier nodes has determined that the candidate block meets the verification criteria, the one or more dissenting verifier nodes are those verifier nodes that determined that the candidate block does not meet the verification criteria. Conversely, where a majority of the verifier nodes has determined that the candidate block does not meet the verification criteria, the one or more dissenting verifier nodes are those verifier nodes that determined that the candidate block does meet the verification criteria.

Preferably, after identifying a dissenting verifier node, each of the other verifier nodes checks the determination made by the dissenting node using the evidence data output by the dissenting node. This can make it more straightforward for disagreements within the set of verifier nodes to be resolved. Thus, preferably, the method comprises, in response to identifying a dissenting verifier node, some or all of the other verifier nodes using evidence data output by the dissenting verifier node to determine whether the candidate block meets the verification criteria.

The one or more verifier nodes may be configured to send the candidate block to one or more further nodes for further verification after attempting to determine, using evidence data, whether the candidate block meets the verification criteria. Thus, the use of a wider set of nodes may provide a fall-back procedure if a consensus cannot be reached by the verifier nodes alone.

The one or more further nodes are preferably configured to verify the candidate block in substantially the same way as in the preferred embodiments described above. The one or more further nodes may be configured to vote on the correctness of the determination made by the one or more dissenting verifier nodes. The votes may be weighted based on a respective level of deposit or stake (e.g. in a cryptocurrency) that each node has in the network. The candidate block may be allowed if there is substantial agreement among the one or more further nodes to allow the candidate block. The candidate block may be rejected if there is not substantial agreement among the one or more further nodes to allow the candidate block. In some embodiments, if there is not substantial agreement among the one or more further nodes to allow the block, the candidate block is sent to every node of the network for verification. Substantial may here mean greater than 50% or greater than 80% or greater than 90%.

In some embodiments, the predetermined period (Pₜ) extends back in time from a time (t) at which the candidate block was created. However, in some embodiments, the predetermined period (Pₜ) extends back in time from an end of a predetermined confirmation period (Cₜ) that extends back in time from a time (t) at which the candidate block was created. The predetermined confirmation period preferably has a duration equal to the length of time for which a block must exist in the blockchain before it is considered immutable. For example, if the confirmation period is defined as two blocks, then a block included in the blockchain is not considered immutable until two further blocks have been added to the blockchain after the block.

The length (i.e. duration) of the predetermined period and/or the length (i.e. duration) of the confirmation period may be determined in terms of astronomical time, or in units of block creation (i.e. numbers of blocks added to the blockchain). For example, the predetermined period may correspond to a constant number of block creations (e.g. five blocks of the blockchain). The blockchain network may be arranged to create blocks at regular intervals, in which case there will be a fixed correspondence between astronomical time and block creation, but this is not essential. In some embodiments, each block comprises a timestamp indicative of a creation time of the block. Nodes may be configured to identify the verifier nodes based on timestamps in blocks of the blockchain, or based on positions of blocks in the blockchain. When determining time in units of block creation, the predetermined period extends from the block created r blocks ago (i.e. before the current candidate block) to the block created R blocks ago (inclusive), wherein r and R are integers and r is less than R. The value r−1 may be the duration, in blocks, of a confirmation period. In embodiments with no confirmation period, then r=1 and R is the length in blocks of the predetermined period.

Preferably the predetermined period defines the maximum number of nodes in the set of verifier nodes. The maximum number of nodes may be between 5 and 500 nodes, e.g. between 50 and 250 nodes, e.g. approximately 100 nodes. The maximum may be determined by risk assessment and may evolve over the history of the blockchain.

In preferred embodiments, the predetermined period is a rolling time period, of constant duration, that shifts each time a candidate block is created. In some embodiments, for at least some of the times when a respective candidate block is created, a respective node of the set of verifier nodes ceases to be part of the set of verifier nodes. This may occur when the time at which this “ex-verifier” node last created a block that has been included in the blockchain no longer falls within the rolling predetermined period. Thus, in some embodiments, the method comprises each of the set of verifier nodes receiving the candidate block of transaction data, and at least one of the set of verifier nodes subsequently ceasing to receive one or more subsequent candidate blocks of transaction data for verification. The ex-verifier node may not cease to receive subsequent candidate blocks indefinitely, as the ex-verifier node may create a further candidate block that is included in the blockchain, and may therefore become eligible as a verifier node once again. An ex-verifier node may, in some embodiments, also still be selected as a further node to receive a candidate block in order to resolve a disagreement after the detection of a dissenting node, e.g. as disclosed above.

The blockchain network may implement a penalty system in which deposits are paid by nodes of the network and are withheld from the nodes at least until one or more conditions for the return of the deposit are met. In some embodiments, a node may be required to pay a creator deposit in order to create a candidate block. The creator deposit may be an amount of cryptocurrency or any other suitable form of stake or holding in the blockchain. Payment of the creator deposit may allow the node to participate in a block-creating lottery. The method may comprise selecting a winning node of a block-creating lottery to create a candidate block. The network may be arranged to reject a candidate block created by some or all nodes that are not the winning node. Preferably the set of verifier nodes are configured to select the winning node.

In some embodiments, multiple candidate blocks may be created at the same time (e.g. within a common block-creating time interval). For example, the method may comprise selecting a winner and one or more runners-up in the block-creating lottery, and each of the winner and the runners-up may be configured to create a candidate block at the same time. The candidate blocks may be sent to the set of verifier nodes for verification according to at least two different priority levels. In some embodiments, a candidate block may be conditionally accepted as a result of the verification by the set of verifier nodes, e.g. on the condition that a higher priority candidate block is rejected. However, in other embodiments, only a single candidate block may be created at each time slot and a rejected block may simply result in an empty time slot. Preferably the method comprises: the network rejecting candidate blocks of transaction data from a block-creating node at least until the block-creating node has paid a creator deposit; the block-creating node paying a creator deposit; and the block-creating node creating a candidate block of transaction data.

Preferably the method comprises withholding some or all of the creator deposit from the block-creating node in response to determining that the candidate block created by the block-creating node has been rejected from inclusion in the blockchain.

In some embodiments, a node may be required to pay a behaviour deposit in order to become a verifier node. Since block-creating nodes may be expected to become verifier nodes in future, the behaviour deposit may form part of the creator deposit. The method may comprise: the network preventing a block creating-node from becoming a verifier node at least until the block-creating node has paid a behaviour deposit; the block-creating node paying a behaviour deposit; and the block-creating node creating a candidate block of transaction data.

The behaviour deposit may be withheld from the node in the event of malicious or careless behaviour by the node. For example, the behaviour deposit may be withheld from a verifier node that fails to determine that an improper candidate block should be rejected, or that fails to determine that a valid candidate block should be approved. This may be determined based on a consensus reached by the set of verifier nodes, or by the one or more further nodes.

Thus, preferably the method comprises: a node paying a behaviour deposit; the node determining that a candidate block meets the verification criteria; the network determining that the candidate block has been rejected; and the network withholding some or all of the behaviour deposit from the node. The method may comprise: a node paying a behaviour deposit; the node determining that the candidate block does not meet the verification criteria; the network determining that the candidate block has been allowed; and the network withholding some or all of the behaviour deposit from the node.

Verifier nodes may be penalised for failing to perform verification of the candidate block and/or for failing to perform verification correctly. Thus, in some embodiments, some or all of a deposit is withheld in response to determining that a verifier node has not determined whether the candidate block meets the verification criteria and/or in response to determining that a recent-block-creator node has not correctly determined whether the candidate block meets the verification criteria.

In some embodiments, the identity of a node from which a deposit has been withheld is published on a data server of the network. The identity may be output (e.g. published) by one or more (e.g. all) of the verifier nodes. The identity may be output by each of the set of verifier nodes to its respective data server.

A node from which a deposit has been withheld may be banned from further participation in the network. A node may be banned immediately following a penalty, or after a predetermined number of penalties.

Withholding deposits from nodes can help to deter nodes from acting maliciously or carelessly, which can improve the robustness of the blockchain. This is particularly the case for verifier nodes, who are responsible for verifying candidate blocks for inclusion in the blockchain and so are naturally relied upon to a greater extend to act appropriately than other nodes of the network.

The steps of creating the candidate block, determining the set of verifier nodes, and sending the candidate block to each of the verifier nodes for verification, are preferably all carried out by a node of the plurality of nodes. Each block-creating node of the network may be configured for carrying out these steps.

The network is preferably decentralised. Actions performed by the network may be performed by any one or more of nodes of the network, acting individually or in a distributed manner. Actions of the network may be performed collectively by some or all nodes of the network. Each node may have a respective identity on the network—e.g. tied to a cryptographic key pair of an operator of the node. Each node may comprise a processor for executing software instructions. Each node may operate according to a common blockchain protocol. A node may have a single network connection to the blockchain network and/or a single network address, although this is not essential—e.g. it may be implemented by a plurality of distributed hardware devices.

When viewed from a second aspect, the invention provides a processing system for a node of a blockchain network, wherein the processing system is configured to:
create a candidate block of transaction data for inclusion in a blockchain hosted by the blockchain network;
determine a set of verifier nodes by identifying nodes of the blockchain network that have each created a respective block that has been included in the blockchain within a predetermined period prior to the creating of the candidate block; and
send the candidate block to each of the verifier nodes for verification.

The processing system may be implemented by a single physical device (e.g. a single block-creating device). However, in some embodiments the processing system may be distributed across a plurality of networked devices, which may be physically distanced from each other, and which may have different respective connections to an underlying physical network. The processing system may act only as a single node of the blockchain network, although it may also perform actions on behalf of a plurality of nodes of the blockchain network.

The blockchain network may comprise a plurality of nodes each of which may comprise such a processing system. Each such processing system may comprise one or more processors. The processing system may be a server.

Preferably the processing system comprises a memory for storing a local copy of the blockchain. The processing system is preferably configured to maintain the local copy of the blockchain, e.g. by updating the head of the blockchain. Preferably the memory stores software, e.g. for maintaining, sharing or updating the local copy of the blockchain. The software may contain instructions which, when executed by a processor, cause the node to send the local copy of the blockchain stored in the memory to other nodes in the blockchain network. The software may contain instructions which, when executed by a processor, cause the node to retrieve updates to the blockchain that are shared by one or more other nodes of the blockchain network.

The processing system may comprise a trusted execution environment (TEE). The trusted execution environment may be a secure processing arrangement, which may form a portion of a larger processing arrangement or processor, such as a central processing unit (CPU). Preferably data stored and/or processed within the trusted execution environment is prevented from being communicated outside the trusted execution environment. In other words, preferably data can be retained securely within the trusted execution environment. The TEE may store data in an encrypted region of memory. Preferably the trusted execution environment is configured to securely attest itself to users and/or other processing systems outside the TEE. One or more of the plurality of nodes may be configured to process data relating to the blockchain within a respective trusted execution environment of such a processing system. In particular a node may be configured to create the candidate block and to determine the set of verifier nodes within a TEE of the node.

It will be appreciated that the respective local copies of the blockchain are not necessarily exact copies. The copies may differ with regard to one or more of the (e.g. most recent) blocks.

The blockchain may be configured to store cryptocurrency. In some embodiments, the blockchain may be configured to store smart contracts.

Each of the plurality of nodes is preferably configured to communicate with one or more others of the plurality of nodes, e.g. over a network such as the Internet. The nodes may be configured to communicate with each other by wired or wireless network connections. This allows the nodes to share and update their respective locally stored copies of the blockchain. One or more of the nodes are preferably configured to timestamp communications issued from the node, e.g. to one or more further nodes of the blockchain network. Thus, the processing system may comprise a clock or may be arranged to receive clock signals from an external clock source. The set of verifier nodes may be configured to maintain a timing record of events recorded on the blockchain. The timing record may be used to verify one or more verification criteria for the candidate block.

A node may be configured to publish communications using a data server (e.g. a bulletin board), hosted by the node or elsewhere on the blockchain network. A node may be configured to output communications to a respective data server, hosted by the node itself. Preferably, a node is configured to timestamp communications uploaded by the node to the data server.

Preferably, the node is configured to sign communications output by the node. Thus, in some embodiments, creating a candidate block of transaction data comprises signing the candidate block with a unique signature. Preferably the unique signature allows the node responsible for creating the candidate block to be identified. Thus preferably the unique signature corresponds to the node creating the block.

In some embodiments, the processing system is configured to create transaction data, e.g. for inclusion in a pool of unverified transaction data.

The processing system may be configured to determine the set of verifier nodes by inspecting a local copy of the blockchain in order to determine which nodes have created blocks that have been included in the blockchain within the predetermined period. In preferred embodiments, the processing system is configured to determine the set of verifier nodes by reading the signatures of the blocks that have been included in the blockchain within the predetermined period.

In some embodiments, the node creating the candidate block may (already) be a verifier node itself. This may occur if the node has created two blocks that were both included in the blockchain within the predetermined period. In this case, it will be appreciated that the set of verifier nodes to which the node sends the candidate block would not necessarily include the node itself.

The processing system may be configured to send the candidate block as an outgoing candidate block. The candidate block may be sent directly to other nodes, or the processing system may cause it to be sent through an agent or proxy. The processing system may be configured to receive incoming candidate blocks (i.e. when the processing system is a verifier node).

When viewed from a third aspect, the invention provides a blockchain network comprising a plurality of nodes, wherein the blockchain network hosts a blockchain and is configured to:
create a respective candidate block of transaction data for inclusion in the blockchain;
determine a respective set of verifier nodes by identifying nodes of the blockchain network that have each created a respective block of that has been included in the blockchain within a predetermined period prior to the creating of the respective candidate block; and
send the respective candidate block to each of the verifier nodes of the respective set of verifier nodes for verification.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Some embodiments of the invention will now be described, by way of non-limiting example only, with reference to the accompanying drawings in which:

FIG. 1 is a schematic of a blockchain network implementing a method of processing transaction data embodying the invention;

FIG. 2 is a schematic representation of the blockchain data structure maintained by the blockchain network of FIG. 1; and

FIG. 3 is a flow chart of the steps performed by nodes of the blockchain network of FIG. 1; and

FIG. 4 is a flow chart of the steps performed by verifier nodes of the blockchain network of FIG. 1.

### DETAILED DESCRIPTION

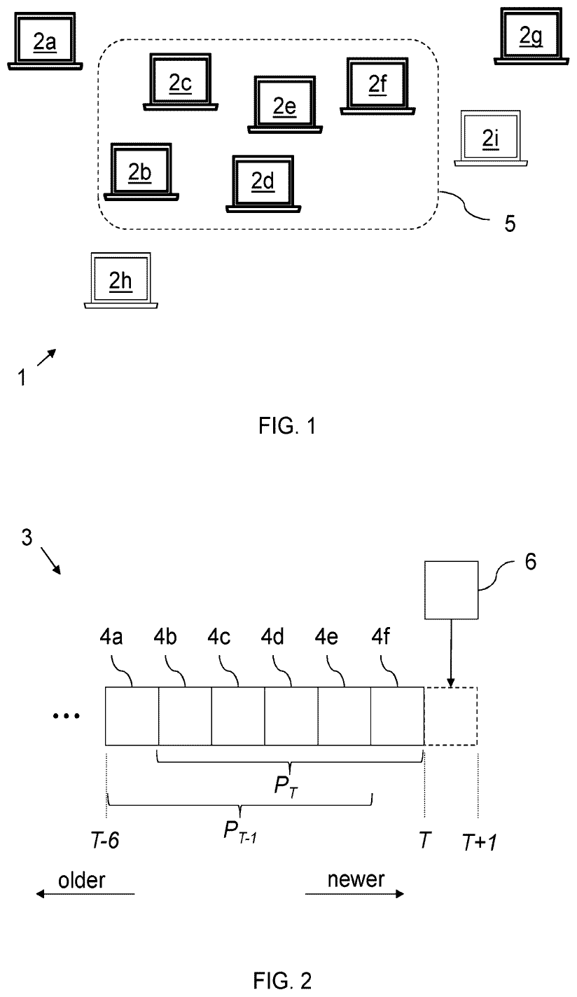

FIG. 1 shows a schematic of a blockchain network 1 implementing the method of processing transaction data in accordance with an embodiment of the present invention. The blockchain network 1 comprises a plurality of nodes 2a-2i that communicate with each other over the Internet to maintain a distributed blockchain 3. Each node is a respective processing system, such as a server, which contains memory and one or more processors executing software for maintaining the blockchain 3. Each node stores a local version (i.e. a copy) of the blockchain 3 in its memory. At any instant the various copies of the blockchain 3 should be nearly identical, but they may differ slightly with regard to the newest entry or entries. Although FIG. 1 shows only nine exemplary nodes 2a-2i, the network 1 may have a large number of nodes. Nodes may join or leave over time.

A subset of the nodes 2a-2g are block-creating nodes, and are configured to create candidate blocks for inclusion in the blockchain 3 based on transactions selected from a pool of unconfirmed transactions. There may be other nodes 2h, 2i that do not undertake block-creating activities, but nevertheless maintain local copies of the blockchain 3. The blockchain network 1 implements a consensus mechanism based around trust, which may also incorporate some elements of proof of stake (PoS) consensus mechanisms.

FIG. 2 shows a representation of the consensus blockchain 3 at a given time t=T. It shows the six most recently-approved blocks 4a-4f of transaction data. In this example, these have been created by six different respective block-creating nodes 2a-2f, although it may also be possible for the same node to have created multiple recent blocks. The blocks 4a-4f have been added to the blockchain 3 and have passed consensus checks sufficiently as to be considered immutable.

In some embodiments, including the example represented in FIG. 2, blocks may be deemed immutable as soon as they are added to the blockchain 3. However, in other embodiments, a provisional block may be required to have been included in the blockchain 3 for longer than a confirmation period Cr, of duration C, in order to be deemed immutable. This confirmation period may, for example, be defined in terms of a number of further blocks that must have been added after the prospective block (e.g. three further blocks, C=3). At any particular moment, some nodes may hold copies of the blockchain 3 that contain one or more provisional blocks, which could potentially be reversed—for instance if a short-lived fork of the blockchain has occurred, which is subsequently resolved by voting or by a longest-chain rule.

FIG. 2 represents the history of the blockchain 3 over time, with time flowing from left to right. Time is here measured in block creation intervals, which may occur regularly in time or at somewhat irregular intervals. Alternatively time could be measured in astronomical time, which may be more or less equivalent in some embodiments (e.g., if the network 1 creates a new block every fixed number of seconds). The most recently approved block 4f of the blockchain 3 at time T is shown on the right hand side of FIG. 2. All of the older blocks of the blockchain 3 extend to the left in FIG. 2.

Five of the blocks 4b, 4c, 4d, 4e, 4f were all added to the blockchain 3 within the period Pₜ immediately preceding a present time t=T. This predetermined “trust” period Pₜ is a fixed-length rolling time period, of duration P, extending back in time from a reference time. It may be measured in numbers of committed blocks, or in astronomical time, or in any other appropriate way. It may extend back in time from the present time t (e.g. from the time of creation of the latest block that has been added to the blockchain). However, in embodiments having a rolling confirmation period, Cₜ, of length C, the trust period Pₜ may instead extend back in time from time t−C—i.e., the trust period, Pₜ, may cover those blocks created in the time interval t−(P+C) to t−C. Any nodes that have created blocks that have been immutably included in the blockchain 3 within the current trust period Pₜ are defined as forming a current set 5 of “verifier” nodes. Thus, when measuring the period in blocks, such that C=r−1 blocks and P=R−r+1 blocks, for some fixed integers r, R with r<R, the verifier nodes are all those who created any of the blocks from r to R blocks behind a current candidate block that is being considered for inclusion, with r=1 in embodiments in which no confirmation period is applied.

Although the example in FIG. 2 shows only five verifier nodes, the trust period may span many more blocks—for example, a hundred or more blocks, thereby allowing the set of verifier nodes to have up to a hundred or more members (e.g. with r=6 and R=105, if a five-block confirmation period is implemented).

At least in some embodiments, block-creating nodes are obliged to become verifier nodes (i.e. they cannot chose not to be, without incurring a penalty).

In example in FIG. 2, the trust period P_{T} corresponds to the period in which the five most recent blocks 4b-4f were (immutably) added to the blockchain 3 (i.e. r=1, R=5). These blocks 4b-4f were created by five block-creating nodes 2b-2f respectively. Thus, in accordance with the present invention, the five block-creating nodes 2b-2f are considered to be verifier nodes 5 at time T. The sixth-oldest block 4a was created by a block-creating node 2a at time T−6, before the current trust period P_{T}, and thus that node 2a will have been removed from the set of verifier nodes 5 shortly before time T, when the current trust period Pₜ changed from being P_{T-1} to P_{T}.

Every block-creating node of the network 1 maintains a local copy of the blockchain 3 and is configured to:
create transactions when asked by an owner of the node, while ensuring they are legal;
submit bids to create blocks (if these are not implemented automatically);
monitor for when it is selected to create a block;
be on standby to carry out extended checking to help resolve disagreements between verifier nodes;
perform routine storage and communication functions; and
update the record of the head of the blockchain by monitoring the verifier nodes and wider protocol as needed.

The verifier nodes 5 do all of this and are additionally required to:
maintain a timing record of events recorded on the blockchain 3;
compute the winners of a block-creating lottery;
verifying that candidate blocks meet verification criteria set by the blockchain network 1;
implement a consensus protocol involving sharing its verification results and by collecting verification results from other nodes; and
communicate with the other verifier nodes to ensure that messages broadcast by block-creating nodes are unambiguous (e.g. to detect if a malicious actor causes conflicting blocks to be issued to different nodes).

Between time T and a later time T+1, a candidate block 6 of transaction data is created by a further block-creating node 2g of the blockchain network 1. This node 2g has been selected to create the next block in a lottery managed by the verifier nodes 5.

This node 2g identifies the verifier nodes 5 by inspecting its copy of the blockchain 3 to determine which nodes have created blocks that were (immutably) included in the latest trust period Pₜ. It then sends a copy of the candidate block 6 to each of the verifier nodes 5 for verification.

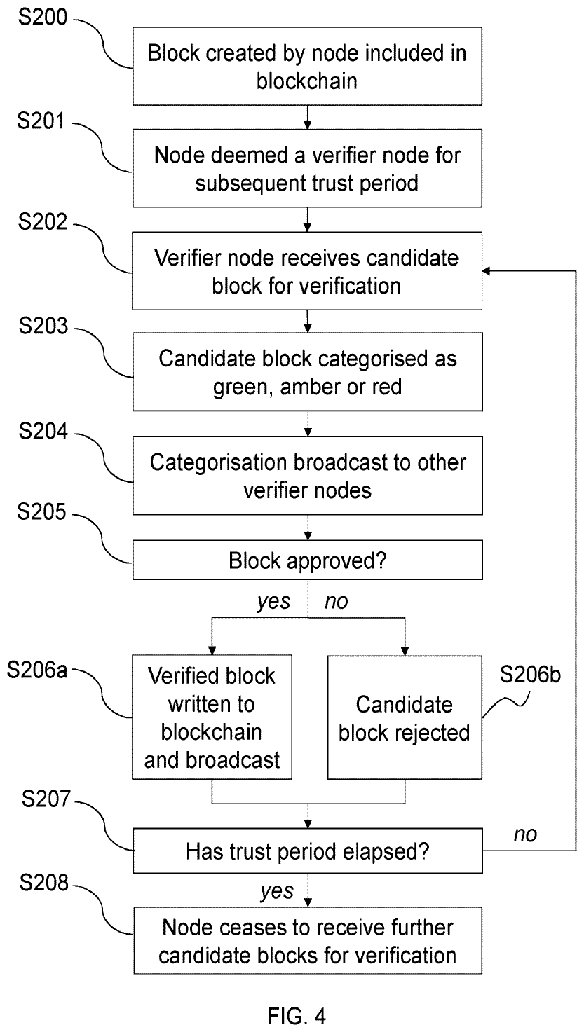

The verification process performed by the verifier nodes 5 is described in more detail below, with reference to FIG. 4.

At time T+1, if the candidate block 6 is approved by the verifier nodes 5, the candidate block 6 will be added to the blockchain 3. Thus, at time T+1, the block-creating node 2g will meet the requirements for becoming a verifier node 5, as it will have successfully created a block 6 that has been added to the blockchain 3 (and existed on the blockchain 3 for longer than the confirmation period), and it will have done so within the trust period P_{T} immediately preceding the time T+1.

Furthermore, at time t=T+1, the block-creating node 2b that was responsible for creating the approved block 4b will no longer be considered a verifier node 5. This is because, at time T+1, the rolling time period Pₜ will no longer include the time at which the block 4b was added to the blockchain 3.

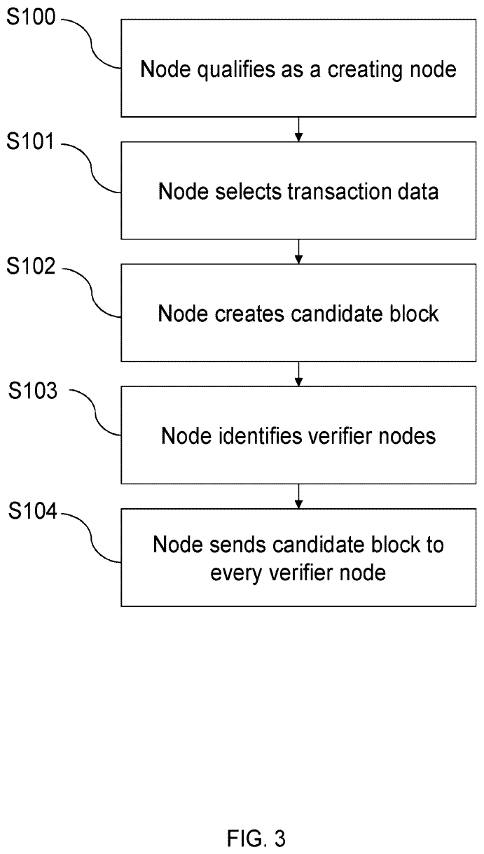

FIG. 3 shows a flow chart of the steps performed by nodes of the blockchain network 1, such as the block-creating nodes 2a-2g of FIG. 1.

In step S100, a node qualifies as a block-creating node. In some exemplary networks 1, a node attempts to qualify as a block-creating node by paying a creator deposit that is written as a transaction on the blockchain 3. The creator deposit acts as a ticket to enter a lottery for the privilege of creating a candidate block. The winner of the lottery, at each time interval, is determined by the set of verifier nodes 5 at random. The value of the creator deposit includes at least the maximum amount that can be collected by the node as a reward for creating a single block, and may also include the sum of any other deposits paid. The node may be configured to pay creator deposits repeatedly over time in order to qualify as a block-creating node.

Once a node has qualified as a block-creating node, the node selects a set of transaction data from a pool of unconfirmed transactions, i.e. transactions that have yet to be included in a block on the blockchain 3 (step S101). The pool of unconfirmed transactions is distributed between the nodes of the blockchain network 1 by known techniques and is stored in the memory of the node. The set of transaction data selected by the block-creating node may be selected according to any suitable or desired criteria, e.g. according to the age or value of each unconfirmed transaction.

In step S102, the block-creating node performs an operation on the selected set of transaction data to create a candidate block for inclusion in the blockchain 3, e.g. using methods known in the art. Each block of transaction data written to the blockchain 3 contains a hash of the block that comes before it in the blockchain 3. It also identifies the block-creating node that was responsible for verifying the transaction data and creating the block (e.g. by means of a cryptographic signature). In step S103, the block-creating node identifies the current set of verifier nodes 5 from the blocks of the blockchain 3 falling within the current trust period Pₜ.

In step S104, the candidate block created by the block-creating node is transmitted to all the set of verifier nodes 5 for verification (excluding from the block-creating node itself, if it would otherwise be in the verifier set due to having also created an earlier block within the trust period). At this stage, the candidate block is not transmitted to any nodes not falling within the set of verifier nodes 5.

FIG. 4 shows a flow chart of the steps performed by each of the verifier nodes 5.

In step S200, a block of transaction data, created by a block-creating node of the blockchain network (which may or may not already be in the verifier set 5), is included in the blockchain 3. After the block has existed on the blockchain 3 for the length of any fixed confirmation period, which is time taken for the block to be considered immutable, or immediately if no confirmation period is required, the block-creating node responsible for creating the block is deemed to be a verifier node (step S201) by other nodes of the network 1. The block-creating node will then be considered a verifier node for the fixed trust period.

Upon becoming a verifier node 5, the node is required to pay a behaviour deposit. The behaviour deposit is returned to the node once the node ceases to be a verifier node 5, unless the return of the deposit is prevented owing to “bad behaviour” of the node, as will be explained in more detail below.

In step S202 the (now verifier) block-creating node receives a candidate block created by another block-creating node of the blockchain network 1. The candidate block is sent to each of the verifier nodes 5 in accordance with the method described above and shown in FIG. 3.

In step S203, each of the verifier nodes 5 performs checks on the candidate block in order to verify that it meets the requirements for inclusion in the blockchain 3—i.e. that it meets one or more verification criteria. The criteria include primary criteria, which are essential requirements for the candidate block to meet in order for it to be included in the blockchain 3, and secondary criteria, which are preferred but non-essential requirements—relating, for example, to timing deadlines.

Each of the verifier nodes 5 categorises the candidate block as “green”, “amber” or “red”. A categorisation as “green” indicates that the candidate block meets all of the verification criteria for inclusion in the blockchain 3. A categorisation as “amber” indicates that all of the primary criteria for inclusion in the blockchain 3 have been met by the candidate block, but that the verifying node believes one or more secondary criteria have not been met. A candidate block is categorised as “red” if the block fails to meet one or more of the primary criteria.

Primary criteria may include that the block must:
be correctly formatted; and/or
not include a “double spend” of cryptocurrency; and/or
contain certain endorsements; and/or
provide evidence that the node that created it had the right to do so (being associated with a winning ticket).

Secondary criteria may include that the block should:
meet certain timing deadlines; and/or
include certain non-critical information.

In step S204, each of the verifier nodes 5 broadcasts its categorisation of the candidate block to the other verifier nodes 5 in order to establish whether a consensus has been reached as to whether the candidate block is verified as meeting the requirements for inclusion in the blockchain 3 (step S205).

If a verifier node 5 categorises a candidate block as “red”, then the verifier node broadcasts this categorisation to the other verifier nodes 5 with a checkable reason (i.e. evidence). The checkable reason is posted onto a bulletin board, hosted by the node 5 and readable by all the other nodes of the blockchain network 1. This makes it more straightforward for the categorisation to be checked by other nodes.

If a majority of the verifier nodes 5 categorises the candidate block as “green”, and none of the verifier nodes 5 categorise the candidate block as “red”, then the candidate block is verified. In this case, each of the verifier nodes 5 adds the candidate block to their stored version of the blockchain 3 and broadcasts the updated blockchain 3 to the other nodes of the blockchain 3 network 1 (step S206a).

If a majority of the verifier nodes 5 categorises the candidate block as “amber” or “red”, then the candidate block is rejected (step 206b). This means that the candidate block is not broadcast to the other nodes of the blockchain network 1.

If a majority of the verifier nodes 5 categorises the candidate block as “green”, but one or more of the verifier nodes categorises the candidate block as “red”, then the verifier nodes 5 may be asked to reassess the block in light of the evidence posted on the bulletin board(s) of the node(s) that issued the “red” categorisation. If consensus is still not reached, the candidate block is broadcast to a wider set of nodes of the blockchain network 1 to try to resolve the disagreement. The wider set of nodes may then be a subset of all nodes, selected at random by the network 1 (e.g. by the verifier nodes 5), or it may contain, or be selected from, every node that has a minimum level of deposit or stake in the network 1 (e.g. having a non-zero cryptocurrency holding). If the set is picked at random, the selection should be made in a way that is not predictable at the point that the dispute arose. The wider set of nodes checks the “red” categorisation of the candidate block; these nodes may, as part of the checking, access and analyse the reason given for the initial “red” categorisation. These checking nodes may issue similar categorisations, or may vote on the correctness of the “red” categorisation. In some embodiments their votes may be weighted based on deposit or stake level. If there is no substantial agreement from the wider set (e.g. more than 80% confirming as “red” or more than 80% not classifying as “red”), the candidate block is sent to every available node, and all nodes check the categorisation to reach a final consensus as to whether the candidate block should be accepted and included (step S206a) or be rejected (step S206b).

Once a consensus has been reached concerning the candidate block (steps S206a and S206b), if the block is rejected, the block-creating node that created the block is penalised by forfeiting some or all of its creator deposit.

This approach of subjecting a block to wider investigation if even a single verifier node categorises it as “red” makes the blockchain 3 extremely robust against malicious actors. Even if a majority of the verifier nodes were compromised and acting in a coordinated malicious fashion, this could still be insufficient to undermine the blockchain 3, since even a single uncompromised verifier node could potentially prevent an attack, by involving the wider set of nodes in scrutinising candidate blocks.

If a verifier node or nodes incorrectly categorised an accepted candidate block as “red”, as determined by the larger group of nodes, the verifier node will be penalised. The penalty is effected by withholding some or all of the behaviour deposit paid by the node upon becoming a verifier node 5. In some embodiments, if a verifier node categorised a block as “green” (or as “green” or “amber” in some embodiments), and that block was ultimately rejected by the wider subset of nodes, or by all available nodes, that verifier node may also be penalised, for having overlooked the fault.

The identities of block-creating or verifier nodes that have been penalised are published on the bulletin board of the blockchain network 1, and these nodes may be banned from participation in the network 1 immediately or after a certain number of penalties.

These deposit and publication penalties deter nodes, especially the verifier nodes, from acting carelessly or maliciously. In this way disagreements between the verifier nodes should be rare.

Except in the rare case of being banned from the network 1, a verifier node will continue to receive further blocks for verification until the time of the last block it created falls outside the current trust period Pₜ. If it is selected to create another block before this happens, it can extend its time as a member of the set of verifier nodes.

In step S207, if the block-creating node is still considered to be a verifier node (i.e. because the current trust period Pₜ still covers the time at which a block mined by the mining node was added to the blockchain 3) then the process loops back to step S202 and, together with the other nodes in the set of verifier nodes 5 (the members of which will change over time), the block-creating node receives a further candidate block for verification. However, if the block-creating node is no longer considered a verifier node, then the process continues to step S208. In step S208, the block-creating node ceases to receive further candidate blocks for verification. This is because candidate blocks are routinely sent only to verifier nodes 5, which the block-creating node has now ceased to be. The block-creating node will not receive further candidate blocks until it creates a further block of transaction data that is immutably added to the blockchain 3, at which point the process of FIG. 4 will start again from step S200.

In some embodiments, all the nodes of the network are required to have accurate clocks and to include timestamps in messages they send. In particular, all information that a node announces on its bulletin board should be timestamped. All announcements on bulletin boards are also accompanied by hashes—e.g. as part of a signature. When a node identifies information that it needs for some purpose, such as to support a categorisation decision, it first posts it on its own bulletin board, and only then uses it. Thus it will always be apparent to other nodes what information a verifier node has used to make a decision. This can help make it clear when there are discrepancies.

This can allow a verifier node to:
check that it has all relevant information from all, or at least a large subset, of the other verifier nodes;
seek information it is missing by copying from the bulletin boards of other verifier nodes; and
identify misbehaviours arising from inconsistencies in information between verifier nodes.

Thus, during the verification and checking of a candidate block the block may be approved immediately when the initial verdicts are collected from the verifier nodes, or there may be one or more “red” categorisations with evidence (e.g. a reason for the “red” categorisation) that needs checking, in which case the verifier nodes recheck based on this evidence. (It may be that some primary criteria are such that evidence is required to detect a failure to meet the criteria, and this evidence may not have been available to all the verifier nodes during the initial verification round.) After this, a dominating majority decision may be arrived at, and the acceptance or rejections of the block is thus decided, or, if not, the blockchain network invokes a backup decision procedure, based on the evidence collected—e.g. by consulting a wider set of nodes, as described above.

If multiple blocks are proposed by a winner and runner(s) up of a block-creation lottery, it may be possible to approve a block conditionally on a given set of blocks being rejected. Such a block would be given a rating that clearly indicates the status it would have if higher priority blocks are rejected. An alternative to this is only looking at such blocks after the higher priority ones are rejected.

The protocol implemented by the network 1 is such that ideally, within the interval allowed for each new block to be included in the blockchain, there is time for at least a substantial majority of the verifier nodes to initially assess a candidate block, publish information using bulletin boards, reassess in case of disagreement, and potentially to select a replacement block. Thus all verifier nodes and a node elected to create a next block should be able to see the results of the verification before the next block is created.

The network 1 thus aims to enable a dominating majority of verifier nodes 5, basing their decision on the same information, to agree on verification decisions. Such verdicts are binding. If no such agreement can be reached, a wider population of nodes is brought in, possibly with some delay. Where a verifier node has published a decision that is strongly inconsistent with the verdict of a dominating majority of verifier nodes, it may be punished.

In this way, the blockchain network 1 can perform secure and efficient verification of candidate blocks, by making use of a rolling set of verifier nodes 5 that have demonstrated a recent stake in the blockchain.

1. A method of processing transaction data for inclusion in a blockchain hosted by a blockchain network comprising a plurality of nodes, the method comprising:
creating a candidate block of transaction data;
determining a set of verifier nodes by identifying nodes of the blockchain network that have each created a respective block that has been included in the blockchain within a predetermined period prior to the creating of the candidate block; and
sending the candidate block to each of the verifier nodes for verification.

2. The method of claim 1, comprising using positions of blocks in the blockchain, or timestamps within blocks of the blockchain, to identify nodes of the blockchain network that have each created a respective block that has been included in the blockchain within the predetermined period.

3. The method of claim 1, comprising receiving the candidate block of transaction data at each of the set of verifier nodes.

4. The method of claim 3, comprising each of the verifier nodes verifying the candidate block by determining whether the candidate block meets one or more verification criteria.

5. The method of claim 4, comprising, in response to determining that at least one of the set of verifier nodes has determined that the candidate block does not meet the verification criteria, rejecting the candidate block.

6. The method of claim 4, comprising each of the verifier nodes outputting verification data indicating whether each of the verifier nodes has determined that the candidate block meets the verification criteria.

7. The method of claim 6, wherein the verification data is readable by each of the verifier nodes.

8. The method of claim 7, comprising each of the verifier nodes outputting verification data to a data server.

9. The method of claim 8, wherein the data server is readable by one or more further nodes of the network in addition to the verifier nodes.

10. The method of claim 4, wherein the one or more verification criteria comprise:
one or more primary verification criteria, corresponding to one or more requirements that the candidate block must meet in order for the candidate block to be included in the blockchain; and
one or more secondary criteria, corresponding to one or more non-essential requirements that it is desirable, but not essential, for the candidate block to meet.

11. The method of claim 10, comprising each of the verifier nodes categorising the candidate block into one of three categories:
a first category, indicating that the candidate block meets all of the primary verification criteria and all of the secondary verification criteria;
a second category, indicating that the candidate block meets all of the primary verification criteria but does not meet all of the secondary verification criteria; or
a third category, indicating that the candidate block does not meet all of the primary verification criteria.

12. The method of claim 10, comprising, in response to a majority of the verifier nodes determining that the candidate block meets all of the primary verification criteria, and none of the verifier nodes determining that the candidate block does not meet all of the primary verification criteria, allowing the candidate block to be added to the blockchain.

13. The method of claim 10, comprising, in response to a majority of the verifier nodes determining that the candidate block does not meet one or more of the primary verification criteria, rejecting the candidate block from inclusion in the blockchain.

14. The method of claim 10, comprising, in response to determining that i) a majority of the verifier nodes have determined that the candidate block meets all of the primary verification criteria, and ii) at least one of the verifier nodes has determined that the candidate block does not meet one or more of the primary verification criteria, one or each of the verifier nodes sending the candidate block to one or more further nodes of the plurality of nodes for further verification.

15. The method of claim 14, wherein the one or more further nodes are selected at random from the plurality of nodes.

16. The method of claim 4, comprising:
identifying one or more dissenting verifier nodes that have made a different determination regarding whether the candidate block meets the verification criteria than a majority of the verifier nodes; and
in response to identifying a dissenting verifier node, some or all of the other verifier nodes using evidence data output by the dissenting verifier node to determine whether the candidate block meets the verification data.

17. The method of claim 16, wherein the evidence data output by the dissenting verifier node indicates a reason for the determination made by the dissenting verifier node as to whether the candidate block meets the verification criteria.

18. The method of claim 16, comprising the one or more verifier nodes sending the candidate block to one or more further nodes of the plurality of nodes for further verification after attempting to determine, using the evidence data output by the dissenting verifier node, whether the candidate block meets the verification criteria.

19. The method of claim 1, wherein the predetermined period extends back in time from a time at which the candidate block was created, or from an end of a predetermined confirmation period that extends back in time from a time at which the candidate block was created.

20. The method of claim 1, wherein the predetermined period corresponds to a constant number of block creations.

21. The method of claim 1, comprising each of the set of verifier nodes receiving the candidate block of transaction data, and at least one of the set of verifier nodes subsequently ceasing to receive one or more subsequent candidate blocks of transaction data for verification.

22. The method of claim 1, comprising:
the network rejecting candidate blocks of transaction data from a block-creating node of the plurality of nodes at least until the block-creating node has paid a creator deposit;
the block-creating node paying a creator deposit; and
the block-creating node creating a candidate block of transaction data.

23. The method of claim 22, comprising withholding some or all of the creator deposit from the block-creating node in response to determining that the candidate block created by the block-creating node has been rejected from inclusion in the blockchain.

24. The method of claim 1, comprising:
the network preventing a block creating-node of the plurality of nodes from becoming a verifier node at least until the block-creating node has paid a behaviour deposit;
the block-creating node paying a behaviour deposit; and
the block-creating node creating a candidate block of transaction data.

25. The method of claim 24, comprising:
a node paying a behaviour deposit;
the node determining that a candidate block meets the verification criteria;
the network determining that the candidate block has been rejected; and
the network withholding some or all of the behaviour deposit from the node.

26. A processing system for a node of a blockchain network, wherein the processing system is configured to:
create a candidate block of transaction data for inclusion in a blockchain hosted by the blockchain network;
determine a set of verifier nodes by identifying nodes of the blockchain network that have each created a respective block that has been included in the blockchain within a predetermined period prior to the creating of the candidate block; and
send the candidate block to each of the verifier nodes for verification.

27. The processing system of claim 26, wherein the processing system is configured to determine the set of verifier nodes by inspecting a copy of the blockchain stored by the node in order to determine which nodes have created blocks that have been included in the blockchain within the predetermined period.

28. A blockchain network comprising a plurality of nodes, wherein the blockchain network hosts a blockchain and is configured to perform the method of claim 1.
